(19) United States
(12) Patent Application Publication
(10) Pub. No.: US 2015/0157520 A1
(43) Pub. Date: Jun. 11, 2015

(54) PATIENT SUPPORT

(71) Applicant: Stryker Corporation, Kalamazoo, MI (US)

(72) Inventors: Jeffrey C. Shiery, East Leroy, MI (US); Christopher Gentile, Sturgis, MI (US); Daniel Vincent Brosnan, Kalamazoo, MI (US); Connor Feldpausch St.John, Marne, MI (US); Gary L. Bartley, Kalamazoo, MI (US); Kevin Charles Kropp, Gobles, MI (US)

(21) Appl. No.: 14/560,193

(22) Filed: Dec. 4, 2014

Related U.S. Application Data
(60) Provisional application No. 61/912,327, filed on Dec. 5, 2013.

(51) Int. Cl. A61G 7/05; G01G 19/44; A47C 19/02

(52) U.S. Cl. CPC A61G 7/05; A47C 19/021; G01G 19/44; A61G 2007/0527

(57) ABSTRACT

A patient support comprising a first structure, a second structure adapted to support the weight of a patient and spaced from the first structure, at least one force sensor mounted to the first structure, and a mounting structure mounting the second structure relative to the sensor, which is adapted to transfer normal forces to the sensor but absorb lateral and/or vibration forces so as not to transfer those forces to the sensor.

This application claims the benefit of U.S. provisional application 61/912,327, filed Dec. 5, 2013, which is incorporated by reference herein in its entirety.

### TECHNICAL FIELD AND BACKGROUND OF THE INVENTION

The present invention relates to a patient support, and more specifically to the frame of a patient support.

Conventional hospital beds typically have a support frame and a deck, which supports a mattress and is mounted to the support frame by a deck frame. The deck frame provides mounts for deck actuators and hinge points for the deck so the head and foot sections of the deck may be articulated to change the angle of the head and foot ends of the mattress. ICU beds in particular may incorporate a variety of electronics to monitor the patient and components of the bed. For example, in order to monitor the weight and/or position of a patient, the bed may incorporate load cells mounted between the support frame and the deck frame, which generates signals in response to the loads applied to the load cells.

It has become increasingly important to accurately measure and monitor the weight of patients because medication doses are often prescribed based on the patient's weight. However, load cells can vary in the accuracy, which stems from the spring-like behavior of load cells. Current load cell placements in hospital beds, however, tend to subject to forces in addition to the patient's weight, especially when subject to vibration. For example, lateral and/or vibration forces may occur due to the movement of the deck and/or side rails, and also due to the added weight of the various accessories and components often supported on hospital beds.

### SUMMARY OF THE INVENTION

Accordingly, the present invention provides a patient support with a frame that reduces the influence of lateral or vibration forces on the sensors that are used to measure and monitor the weight and/or position of a patient.

In one embodiment, a patient support includes a first structure, a second structure adapted to support the weight of a patient and spaced from the first structure, and at least one force sensor mounted to the first structure. The patient support also includes an elastic member that suspends the second structure above the sensor.

In another embodiment, a patient support includes a first structure, a second structure adapted to support the weight of a patient, and at least one force sensor mounted to the first structure. The patient support includes an elastic member that transfers a vertical load from the second structure to the sensor.

In another embodiment, a patient support includes a first structure, a second structure adapted to support the weight of a patient, and at least one force sensor mounted to the first structure. The patient support also includes an elastic member mounted to the second structure and connected to the sensor by a coupler, such as a fastener. The coupler is, however, not directly coupled to the second structure such that when loads from the second structure are transferred to the elastic member, the elastic member absorbs some of the lateral forces and/or vibration from the second structure thereby transferring only vertical loads from the second structure to the coupler and then to the sensor.

In any of the above, the elastic member includes at least one flange, with flange being mounted to the second structure.

In a further aspect, the elastic member includes two flanges. For example, each of the flanges may be mounted to the second structure by a coupler, such as a fastener.

In any of the above, the elastic member may include a hollow region facing the second structure. In a further aspect, the elastic member includes a pair of mounting flanges about the hollow region, with the flanges mounting the elastic member to the second structure.

In any of the above, the elastic member may have a generally cylindrical body or a frustoconical body. Further, the elastic member may include a pair of mounting flanges projecting outwardly from the cylindrical body, with the flanges mounting the elastic member to the second structure.

In yet another aspect, where the elastic member has a cylindrical body, the cylindrical body may include a recessed portion, with flanges projecting outwardly from the cylindrical body about the recessed portion.

In yet another embodiment, a patient support includes a first structure, and a second structure adapted to support the weight of a patient and spaced from the first structure. At least one force sensor is mounted to the first structure, and an elastic member is mounted to the second structure. The elastic member has a first mounting portion and a pair of second mounting portions each on opposing sides of the first mounting portion. Each of the second mounting portions are offset from the first mounting portion, with the second mounting portions being coupled to the second structure, and the first mounting portion being coupled to the sensor. In this manner, forces from the second structure are transferred to the elastic member by the second mounting portions, and at least the second mounting portions absorb some of the forces from the second structure wherein the elastic member transfers only some of the forces from the second structure to the sensor.

According to yet another embodiment, a patient support includes a first structure and a second structure adapted to support the weight of a patient and spaced from the first structure. At least one force sensor mounted to the first structure, and an elastic member is mounted to the second structure. The elastic member has a cylindrical body and a pair of mounting flanges projecting outwardly from the cylindrical body, with the flanges mounting the elastic member to the second structure, and the sensor mounted to the cylindrical body.

In any of the above where the elastic member has a cylindrical body, the cylindrical body may include an annular shoulder, with mounting flanges projecting outwardly from the annular shoulder. For example, the cylindrical body may have a diameter in a range of 0.7 to 2.0 inches, optionally in a range of 0.7 to 1.5 inches, and optionally in a range of 1.2 to 1.5 inches.

In any of the above where the elastic member has a cylindrical body, the support further includes a first coupler, which connects the sensor to the cylindrical body. In further aspects, the first coupler has a longitudinal axis, and the second structure applies a vertical load to the sensor parallel with the longitudinal axis of the first coupler.

In any of the above where the elastic member has mounting flanges, each of the mounting flanges may be mounted to the second structure by a second coupler. Each of the second couplers has a longitudinal axis, with the longitudinal axis of first coupler located between the longitudinal axes of the second couplers. For example, the longitudinal axis of the first coupler may be centered between the longitudinal axes of the second couplers.

In other aspects, the longitudinal axis of first coupler is spaced in a range of about 1.0 to 2.0 inches, optionally in a range of 1.0 to 1.6 inches, and optionally in a range of 1.5 to 1.6 inches from the longitudinal axes of the second couplers.

In other aspects, in any of the above, the elastic member has Shore durometer hardness in a range of about 25 to 95, optionally in a range of about 65 to 95, and optionally in a range of about 65 to 75.

In other aspects, in any of the above, the elastic member has height in a range of about 0.5 to 1.5 inches, optionally in a range of about 0.5 to 1.0 inches, and optionally in a range of about 0.5 to 0.8 inches.

In yet another embodiment, a patient support includes a first structure, a second structure adapted to support the weight of a patient, and at least one force sensor mounted to the first structure. The patient support also includes a mounting assembly that is configured to transfer normal forces from the second structure to the force sensor but absorb lateral forces from the second structure.

In one aspect, the mounting assembly includes at least one damping structure to absorb lateral forces from the second structure. For example, the damping structure may comprise an annular member. A suitable material for the annular member includes an elastomeric material.

In a further aspect, the mounting assembly includes plural damping structures to absorb lateral forces from the second structure. For example, the plural damping structures may comprise ribs that are configured to deform in response to a lateral force.

In yet a further aspect, the mounting assembly includes two concentric sleeves, which are spaced by the ribs. For example, at least one group of the ribs may have a uniform cross-section. In another aspect, at least one group of the ribs has a tapered cross-section.

In still yet another embodiment, a patient support includes a first structure, a second structure adapted to support the weight of a patient, and at least one force sensor mounted to the first structure. The patient support also includes a mounting assembly that transfers normal forces from the second structure to the force sensor. The mounting assembly includes a sliding interface between the second structure and the force sensor along a first axis and a damping interface along a second axis angled with the first axis so that lateral forces are absorbed by the mounting assembly.

For example, the mounting assembly may include a bolt, which mounts to the load cell, and a slotted opening for receiving the bolt. The mounting assembly further includes a sleeve surrounding the bolt, which absorbs lateral loads at the interface.

In one embodiment, the sleeve comprises a first sleeve, and the mounting assembly includes a second sleeve, which is spaced from the first sleeve. In yet a further aspect, the first and second sleeves are joined by ribs, which are designed to crush or deform in response to lateral forces applied at the interface.

In any of the above, the force sensor comprises a load cell.

In any of the above, one or both of the first structure and the second structure comprise a frame, such as a four-sided frame. Further, the patient support may include two sensors mounted to one side of the frame, and another two sensors mounted to the opposed side of the frame.

Before the embodiments of the invention are explained in more detail below, it is to be understood that the invention is not limited to the details of operation or to the details of construction and the arrangement of the components set forth in the following description or illustrated in the drawings. The invention may be implemented in various other embodiments and is capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a patient support which may incorporate a patient support frame of the present invention;

FIG. 2 is a perspective view of a patient support frame according to one embodiment of the present invention;

FIG. 3 is a side elevation of the patient support frame of FIG. 2;

FIG. 4 is an exploded perspective view of the patient support frame of FIG. 2;

FIG. 5 is a plan view of the patient support frame of FIG. 2;

FIG. 6 is a cross-section taken along line VI-VI of FIG. 5;

FIG. 7 is an enlarged detail VII of FIG. 6;

FIG. 8 is a cross-section taken along line VIII-VIII of FIG. 5;

FIG. 9 is an enlarged detail IX of FIG. 8;

FIG. 10 is a plan view of another embodiment of a load cell mounting arrangement on a patient support frame;

FIG. 11 is an end elevation view of the frame of FIG. 10;

FIG. 12 is an enlarged plan view of the load cell mounting assembly arrangement;

FIG. 13 is a plan view similar to FIG. 10 with the load cells removed to illustrate the mounting assembly bracket;

FIG. 14 is a side elevation view of the patient support frame and load cell mounting assembly arrangement of FIG. 13;

FIG. 15 is a plan view of a load cell mounting assembly of FIG. 12;

FIG. 16 is a cross-section view of the load cell mounting assembly of FIG. 15;

FIG. 17 is a cross-section view of the load cell mounting assembly of FIG. 15;

FIG. 18 is an enlarged perspective view of one of the load cell mounting assemblies;

FIG. 19 is an enlarged perspective view of the load cell mounting assembly with the mounting bracket and fastening bolt removed to illustrate an impact absorbing component of the load cell mounting assembly;

FIG. 20 is an enlarged perspective view of another embodiment of the load cell mounting assembly;

FIG. 21 is a cross-section view of the mounting assembly of FIG. 20; and

FIG. 22 is an exploded perspective view of the load cell mounting arrangement of FIG. 20.

### DETAILED DESCRIPTION OF THE PREFERRED EMBODIMENTS

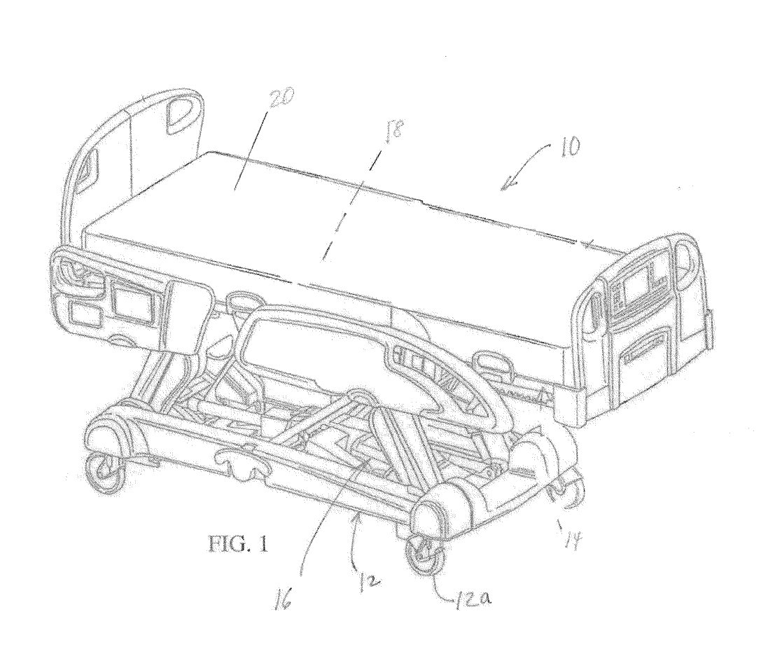

Referring to FIG. 1, the numeral 10 generally designates a patient support according to one embodiment of the invention. In the illustrated embodiment, patient support 10 is a hospital bed, and more specifically an ICU bed. However, it will be understood that patient support 10 may take on other forms, such as stretchers, cots, OR tables, or wheel chairs. As will be more fully described below, patient support 10 includes a patient support frame that is adapted to reduce the influence of lateral and/or vibration forces on the load cells, which are supported on the frame and which are used to measure and/or monitor the weight of a patient, for example, to more accurately determine the weight and/or position of the patient. In general, the patient support frame may be used wherever and whenever a patient is to be supported on a surface and it is desirable to monitor the patient, especially the weight of the patient, for example, for the purpose of determining medication dosages or monitoring patient activity, including bed exit, such as described in U.S. patent application Ser. No. 14/212,367, filed Mar. 14, 2014, entitled PATIENT SUPPORT APPARATUS WITH PATIENT INFORMATION SENSOR (Attorney Docket No. STR03 R&D P413C), and U.S. patent application Ser. No. 14/211,613, filed Mar. 14, 2014, entitled PATIENT SUPPORT APPARATUS WITH REMOTE COMMUNICATIONS (Attorney Docket No. STR03 R&D P414B), which are commonly owned by Stryker Corporation of Kalamazoo, Mich. and incorporated by reference herein their entireties.

As best seen in FIG. 1, patient support 10 includes a base 12, with a plurality of wheels 12a, and a patient support frame 14, which is supported on the base by a lifting mechanism 16. Supported on support frame 14 is a deck 18, which supports a patent support surface in the form of mattress 20. Deck 18 optionally includes a foot section, a head section, and a seat section, with at least the foot and head sections be mounted for pivotal movement to adjust the angle of the head and foot ends of the deck and the mattress. Examples of a suitable deck and actuators for moving the sections of the deck are shown and described in U.S. patent application Ser. No. 11/612,781, filed Dec. 19, 2006, entitled HOSPITAL BED, and issued on Aug. 30, 2011 as U.S. Pat. No. 8,006,332 (Attorney Docket No. STR03B P101A), and U.S. patent application Ser. No. 11/612,428, filed Dec. 18, 2006, entitled HOSPITAL BED, and issued on Apr. 6, 2010 as U.S. Pat. No. 7,690,059 (Attorney Docket No. STR03A P102A), which are commonly owned by Stryker Corporation of Kalamazoo, Mich. and incorporated by reference herein their entireties. Suitable mattresses are described in U.S. patent application Ser. No. 12/640,770, filed Dec. 17, 2009, and entitled PATIENT SUPPORT (Attorney Docket No. STR03A P239A), U.S. patent application Ser. No. 13/022,326, filed Feb. 7, 2011, entitled PATIENT/INVALID HANDLING SUPPORT, and issued on Dec. 16, 2014 as U.S. Pat. No. 8,911,387 (Attorney Docket No. STR03A P257A), U.S. patent application Ser. No. 14/019,353, filed Sep. 5, 2013, entitled PATIENT SUPPORT (Attorney Docket No. STR03A P405E), U.S. patent application No. 14/472,697, filed Aug. 29, 2014, entitled PATIENT SUPPORT (Attorney Docket No. STR03A P-405F), PCT Application No. PCT/US2013/058235, filed Sep. 5, 2013 (Attorney Docket No. STR03A FP-405D WO), and U.S. patent application Ser. No. 13/743,758 filed Jan. 17, 2013, entitled PATIENT/INVALID SUPPORT WITH PRESSURE REDUCING SYSTEM (Attorney Docket No. STR03A P390B), which are commonly owned by Stryker Corporation of Kalamazoo, Mich. and incorporated by reference herein their entireties.

As noted above, support frame 14 is adapted to reduce the influence of lateral and/or vibration forces on the load cells, which are supported on the frame and which are used to measure and/or monitor the weight of a patient, for example, to more accurately determine the weight and/or position of the patient. This is achieved by absorbing most, if not all, the lateral and/or vibration forces that may occur, and transferring essentially only vertical loads to the load cells.

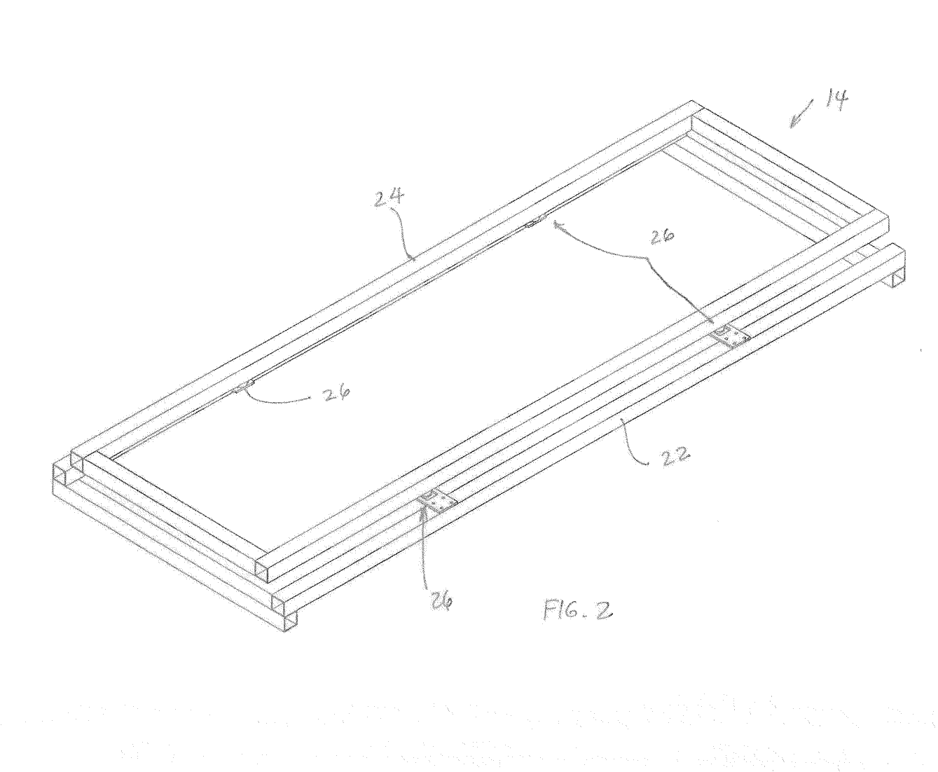

Referring to FIG. 2, in the illustrated embodiment support frame 14 includes a first structure 22 and a second structure 24, which are both adapted to support the weight of a patient. The lifting mechanism is mounted to first structure 22 to raise and lower the deck and the mattress supported thereon. For example, in the illustrated embodiment, each structure 22, 24 includes four tubular members joined together, for example by welds or fasteners or the like, to form four-sided rectangular frames. It should be understood that structures (22, 24) may be formed from other members and further may be formed in other configurations. In addition, though bed frames are typically formed from metal it should be understood that other materials may be used to form the frame members, including composite materials, including fiber reinforced materials.

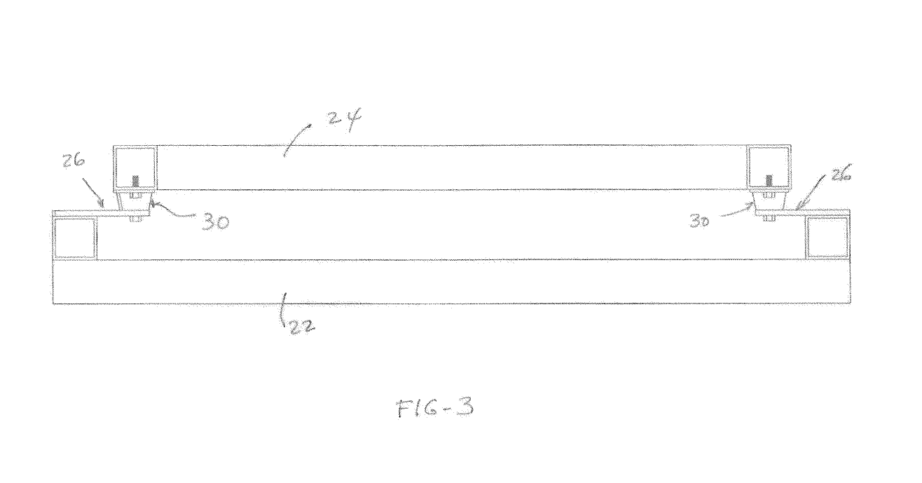

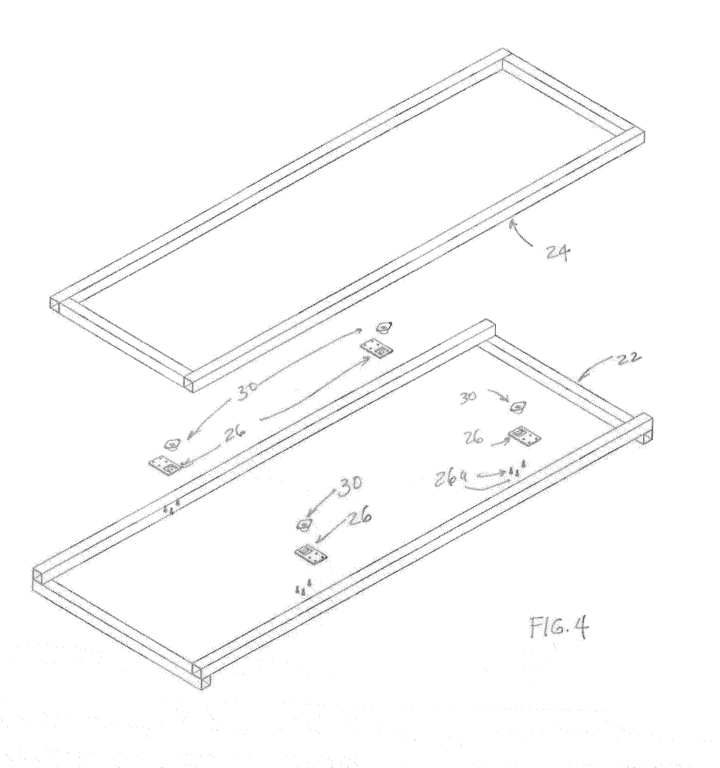

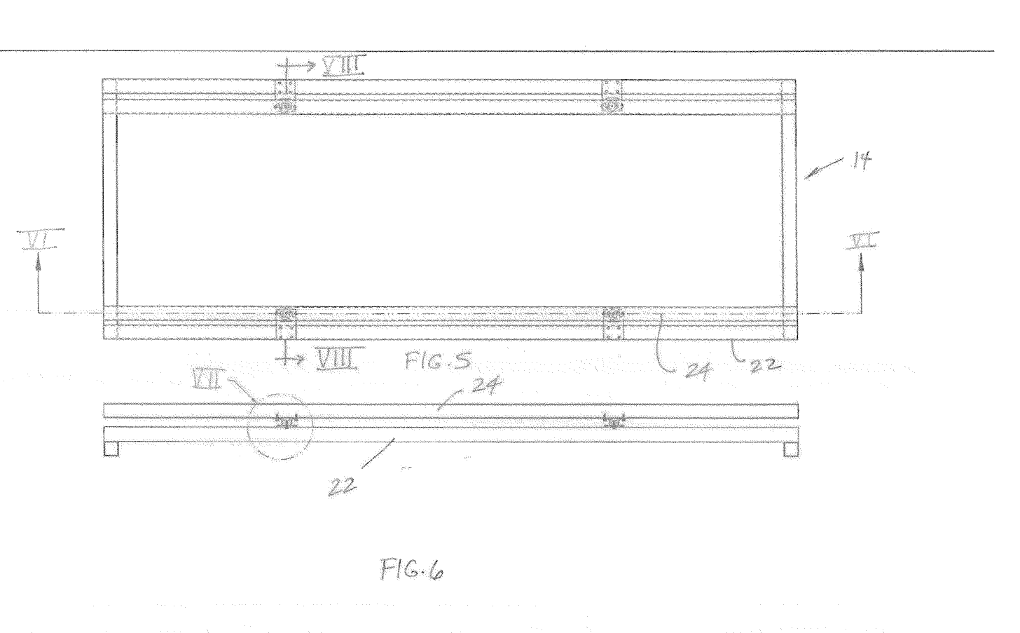

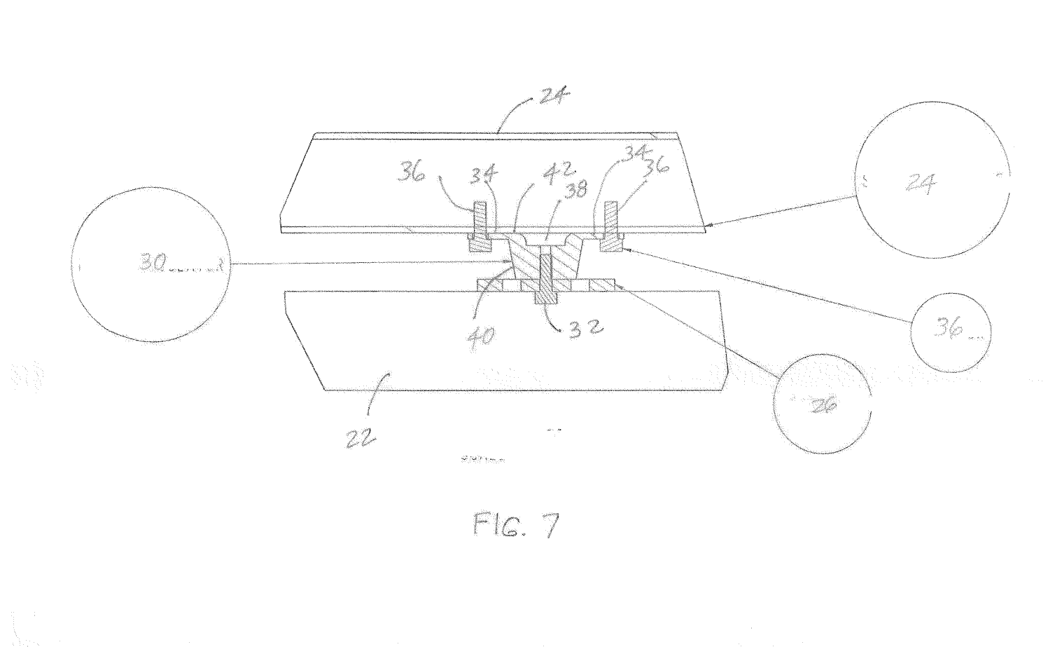

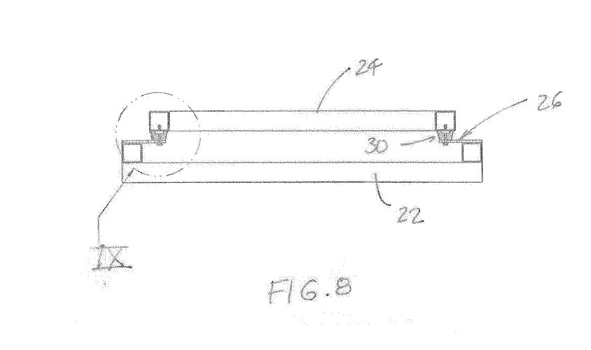

First structure 22 may provide the hinge points (not shown) for the deck and mounting surfaces (not shown) for the actuators that move the section or sections of the deck and therefore form a deck frame for the deck. As best seen in FIGS. 3 and 4, structure 24 is vertically and optionally inwardly spaced from the first structure 22, with one or more force sensors 26, such as load cells, positioned between the two structures (22, 24) and mounted to first structure 22, for example, by way of fasteners 26a.

Patient support frame 14 also optionally includes a plurality of load cell mounting assemblies each with an impact absorbing component in the form of an elastic member 30, which is associated with each sensor that suspends the second structure above the sensor. As will be described below, elastic members 30 are configured to absorb lateral and/or vibration forces that may occur in frame 24. In the illustrated embodiment, support frame 14 includes two sensors (and their corresponding two elastic members) on each of its long sides, with the sensors 26 cantilevered inwardly such that structure 24 is suspended above and inwardly of structure 22.

As best understood from FIG. 7, elastic members 30 transfer vertical forces or loads from the second structure (24) to the sensor. Each elastic member 30 is connected to its respective sensor 26 by a coupler 32, for example, a fastener, such as a bolt. Coupler 32 extends into elastic member 30 but does not pass through the elastic member to second structure 24. In this manner, coupler 32 is not directly coupled to the second structure (24). Consequently, when forces from the second structure are transferred to the elastic member, the elastic member absorbs some of the forces, such as lateral and/or vibration forces, from the second structure thereby transferring substantially only vertical loads from the second structure to coupler 32 and then to sensor 26.

Referring again to FIG. 7, each elastic member 30 includes at least one flange 34, with flange 34 being mounted to the second structure. In the illustrated embodiment, each elastic member 30 includes two flanges 34. For example, each of the flanges 34 may be mounted to the second structure by a coupler 36, such as a fastener, including a bolt, which extend through the wall of the frame members of second structure and are secured therein optionally by a nut (not shown) and/or a threaded opening formed in the members forming structure 24.

Elastic members 30 may each include a hollow region 38, such as a recessed portion, which is oriented to face second structure 24, with flanges 34 projecting outwardly from the hollow region. Together, flanges 34 and hollow region 38 introduce some additional flexibility into member 30 so that when a load is directed through the respective elastic members 30, elastic members 30 can absorb some of the lateral loads and/or vibration that may occur in structure 24, for example, when the deck is articulated or when a side rail is raised or lowered.

In illustrated embodiment, each elastic member 30 includes a generally cylindrical body 40. In other example, elastic member 30 has a frustoconical body. Further, the flanges 34 project outwardly from body 40, with each flange 34 being mounted to the second structure by coupler 36. In addition, hollow region 38 extends into body 40, and optionally about a central longitudinal axis of body 40 so that elastic member 30 may form an annular shoulder 42, which bears against structure 24, when elastic member 30 is mounted to structure 24.

In this manner, elastic member 30 forms a first mounting portion, for example body 40, and a pair of second mounting portions, for example flanges 34, each on opposing sides of the first mounting portion. Thus, each of the second mounting portions is offset from the first mounting portion. Consequently, forces from the second structure are transferred to the elastic member by the second mounting portions, and at least the second mounting portions absorb some of the forces from the second structure wherein the elastic member transfers only some of the forces from the second structure to the sensor.

When assembled, as best seen in FIGS. 7 and 9, the second structure applies vertical loads to the respective elastic members along axes parallel with the longitudinal axis of coupler 32 and central axis of body 40. Further, longitudinal axis of coupler 32 may be located between the longitudinal axes of couplers 36 and optionally may be centered between the longitudinal axes of couplers 36. In addition, coupler 32 may lie in the plane that passes through couplers 36 so that coupler 32 is located at the midpoint of the beam formed by flanges 34 and body 40. For example, the longitudinal axis of coupler 32 may be spaced in a range of about 1.0 to 2.0 inches from the longitudinal axes of the couplers 36, optionally in a range of 1.0 to 1.6 inches, and optionally in a range of 1.5 to 1.6 inches.

Elastic members 30 are optionally formed from an elastomeric material, such as rubber, and may have Shore durometer hardness in a range of about 25 to 95, optionally in a range of about 65 to 95, and optionally in a range of about 65 to 75.

Body 40 may be solid, as shown, or may have additional internal hollow regions to adjust their flexibility. Additionally, the height, width, and thickness of flanges 34 and body 40 may be varied to adjust the response of the elastic members. For example, flanges 34 may have a thickness in a range of about 1/16 to ½ inches, optionally in a range of about ⅛ to 7/16 inches, and optionally in a range of about ¼ to ⅜ inches. The length of flanges 34 may be in about 0.5 to 1.5 inches, optionally in a range of about 0.5 to 1.0 inches, and optionally in a range of about 0.5 to 0.8 inches. Body 40 may have a height in a range of about 0.5 to 1.5 inches, optionally in a range of about 0.5 to 1.0 inches, and optionally in a range of about 0.5 to 0.8 inches and an outside diameter in a range of about 0.7 to 2.0 inches, optionally in a range of about 0.7 to 1.5 inches, and optionally in a range of about 1.2 to 1.5 inches.

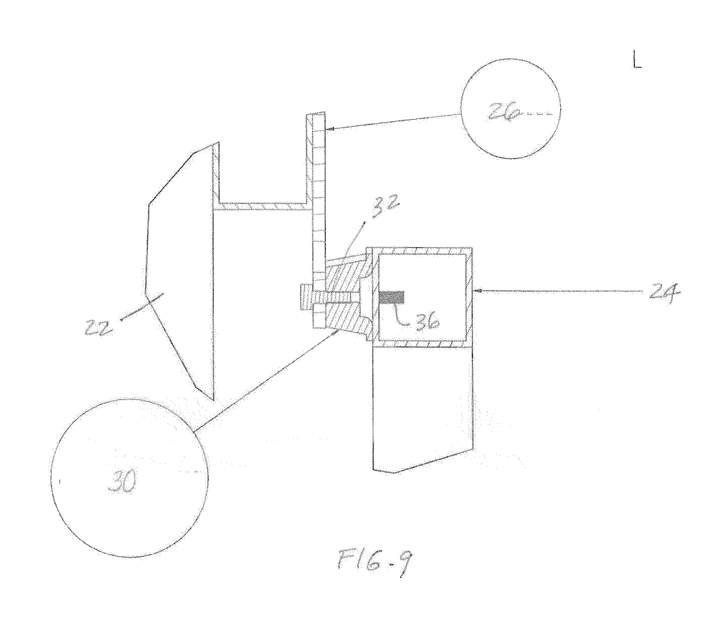

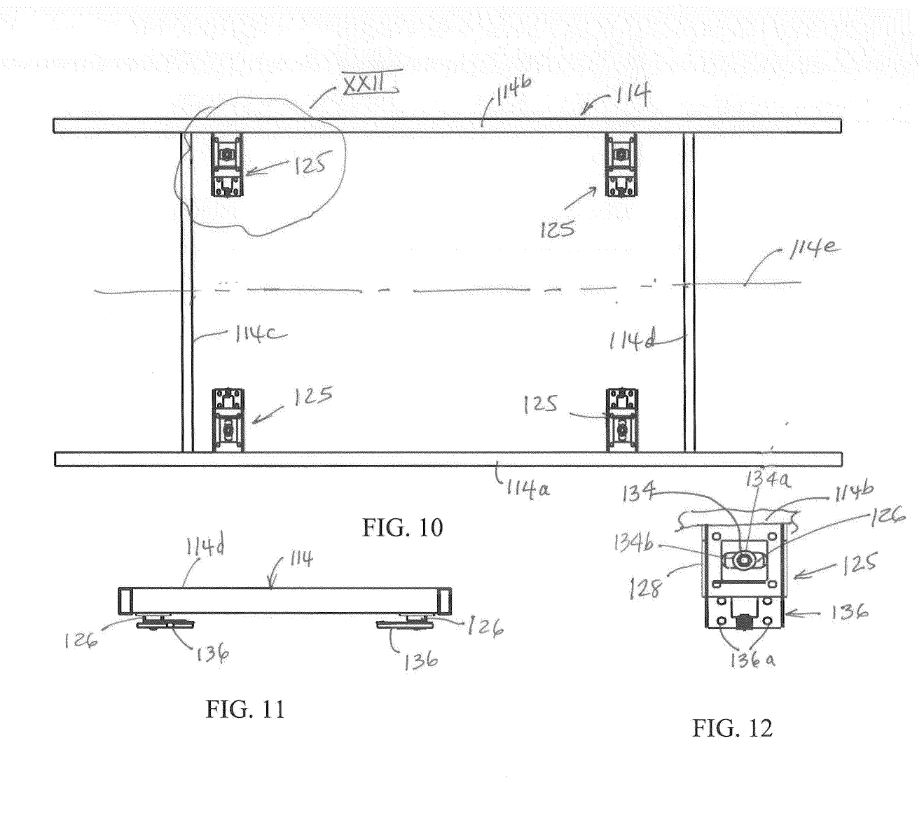

Referring to FIG. 10, the numeral 114 designates another embodiment of a patient support frame with a plurality of load cell mounting assemblies 125. Load cell mounting assemblies 125 are configured to allow normal (perpendicular) forces to be transmitted from frame 114 to the load cells but to absorb lateral and/or vibration forces to provide a more accurate measurement of a patient's weight.

Referring again to FIG. 10, frame 114 includes two longitudinal frame members 114a, 114b, and two transverse frame members 114c, 114d, which are joined together, for example, by welds or fasteners, to form frame 114. As noted above, load cell mounting assemblies 125 are configured to allow normal (perpendicular) forces to be transmitted to the load cells but absorb lateral and/or vibration forces. To achieve this, each load cell mounting assembly 125 includes an impact absorbing component 126 that absorbs lateral forces (and/or vibration forces) at the load cell mounting assembly while allowing the normal forces to transfer to the load cells. Further, as will be more fully described below, impact absorbing component 126 is mounted so that it accommodates lateral movement at the load cell mounting assembly to further assist in absorbing non-normal loads.

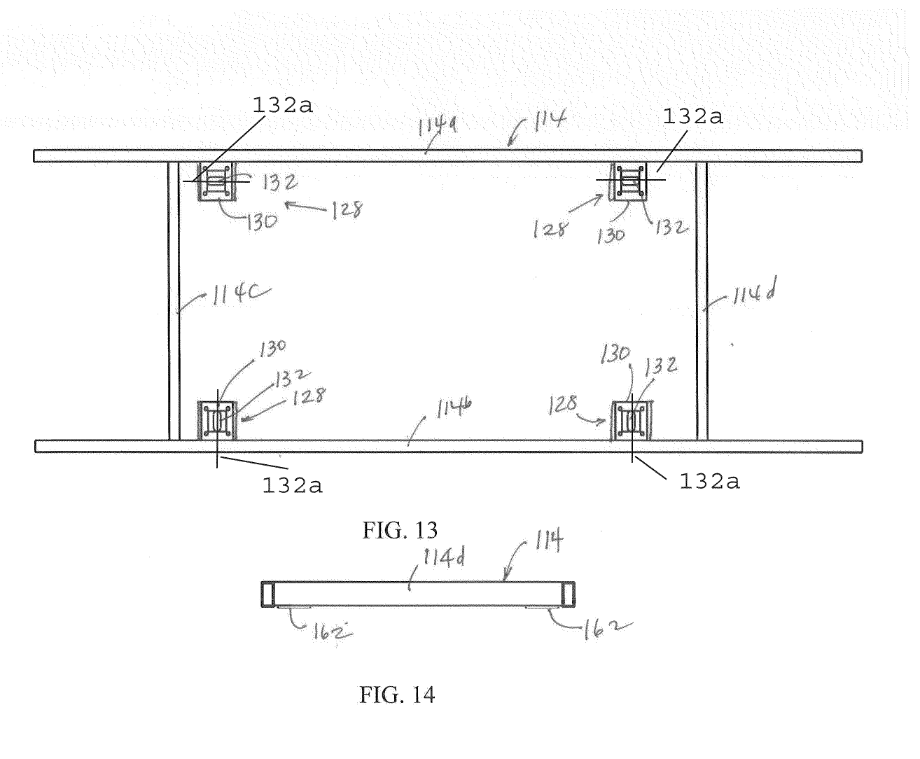

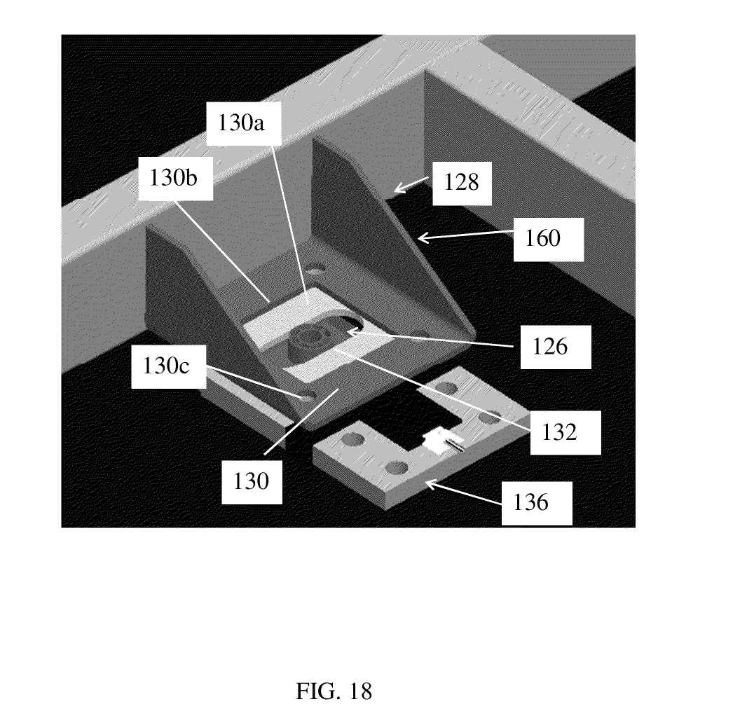

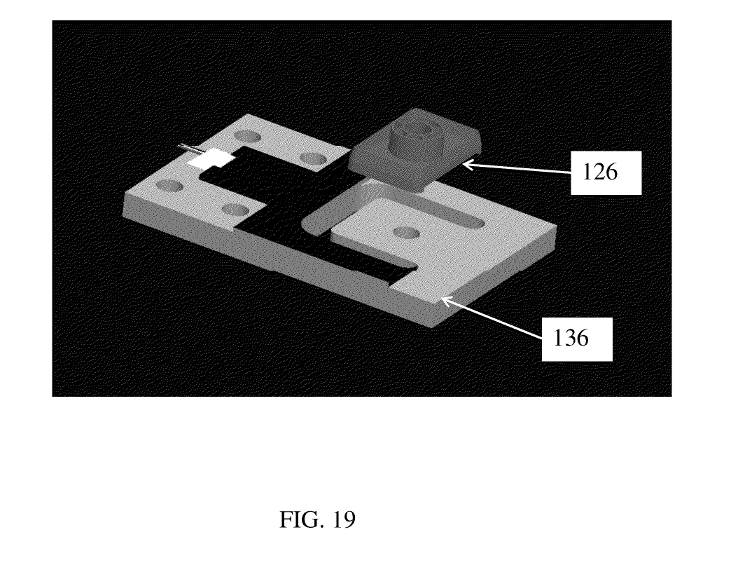

Load cell mounting assemblies 125 are mounted at the inwardly facing sides of longitudinal members 114a, 114b. Each load cell mounting assembly 125 includes a bracket 128. As best seen in FIGS. 13 and 18, each bracket 128 includes a web 130 and a slotted opening 132 for receiving couplers, for example, mounting bolts 134, which mount frame 114 to load cells 136 positioned beneath brackets 125. Load cells 136 are mounted by way of fasteners that extend through mounting holes 136a to a second frame (not shown) beneath frame 114, similar to frame 22 described in reference to the first embodiment. Slotted openings 132, therefore, accommodate lateral or longitudinal movement (depending on their orientation) between frame 114 and the lower frame to eliminate the transfer of lateral forces from frame 114 to load cells 136.

As best seen in FIG. 12, each load cell 136 is mounted to a respective bracket 128 by a coupler, namely a mounting bolt 134. Each bolt 134 extends upwardly through the load cell into a respective bracket through impact absorbing component 126 and is secured to its respective component 126 by a nut 134a and a washer 134b. Each impact absorbing component 126 extends through and interfaces with its respective bracket 128 in slotted opening 132.

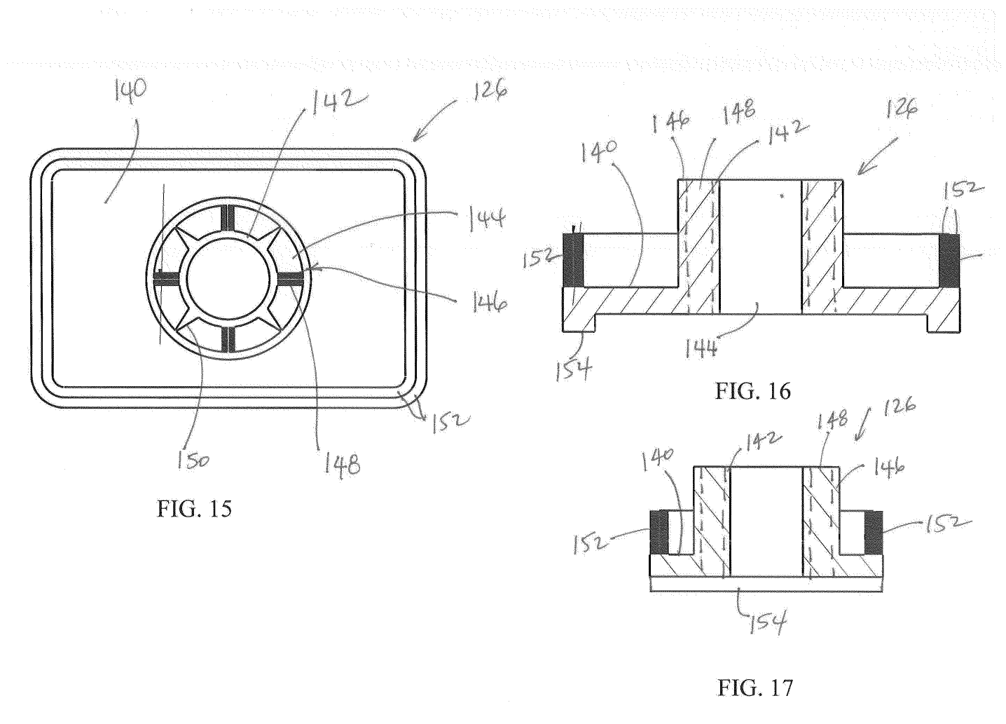

Referring to FIGS. 15-17, each impact absorbing component 126 includes a web 140, for example, a plate element, and a cylindrical sleeve 142, which extends upwardly through an opening 144 formed in web 140. Sleeve 142 is supported in opening 144 by an outer concentric sleeve and a set of radial lateral supports, for example, ribs 148 that are joined at their ends with sleeve 142 and sleeve 146. For example, component 126 may be formed as a molded component so that each of web 140, sleeves 142, 146, and ribs 148 are integrally formed together as a unitary component.

Optionally, sleeve 142 may include a second set of radial lateral supports, for example, ribs 150 with variable cross-sections. In the illustrated embodiment, each rib 150 has a tapered cross-section, such as a triangular cross-section. Ribs 148 each may have a uniform cross-section. In this manner, ribs 148 can absorb lateral loads by buckling or crumpling, while ribs 150 may absorb loads by simply compressing.

In each case, ribs 148 and 150 are designed to crumple, collapse or compress in response to a lateral load, for example, from its respective bolt 134. In this manner, when a lateral force is applied to frame 114, the lateral forces will be absorbed either by the slotted opening and/or the ribs 148 and/or 150 so that the lateral forces will not be transferred to the load cells 136.

Optionally, components 126 may be configured to include additional ribs 152, 154 that crush to absorb additional unwanted forces, such as dynamic vertical forces due to movement of the patient support. Ribs 152, for example, may be provided at the perimeter of web 140 and face upwardly (as viewed in FIG. 16). Ribs 154 may also be provided at the perimeter of web 140 but face downwardly.

Components 126 may be formed from a thermoplastic, a polyester, a polymer, such as santoprene, a nylon, such as an impact modified nylon, including an ABS or Nylon 66. Alternately, components 126 may be formed from a metal, such as aluminum. Further, the material forming components 126 may include reinforced materials or composite materials. For example, a suitable filler or reinforcement may include talc, carbon, fibers, including fiberglass, carbon fibers, or metal flakes.

As described above, components 126 are configured to absorb non-normal forces—the term “non-normal forces” refer to forces that are not normal to the load cell. Absorption may be achieved, as noted by movement, crushing or deforming of one or more elements of components 126. Additionally, components 126 may permanently deform or have spring-like properties so that the element or elements of component 126 restore to their pre-loaded condition. This is achieved through their material selection. For example, as would be understood, materials that have elastic properties, such as modified rubber and nylon, will form elements that can restore themselves to their pre-loaded configuration.

Referring again to FIG. 18, as noted above each bracket 128 includes a web 130 and a slotted opening 132. Slotted opening 132 may be formed in a plate 130a, which is mounted to web 130, which includes an enlarged opening 130b in which slotted opening 132 is located when plate 130a is secured to web 130, for example, by fasteners that extend through mounting openings 130c located around opening 130b.

While only orientations are shown (with one set with their slotted openings running along an axis that is parallel to the longitudinal axis 114e of frame 114, and the other running along axes that are normal to the longitudinal axis 114e of frame 114), it should be understood that the orientation of the slots may vary and be controlled by adjusting the number and location of the mounting openings 130c. Thus, depending on the orientation of plate 130a, the orientation of slotted opening 132 may be adjusted. For example, each slotted opening 132 may be adjusted so that it can be in any orientation in the plane parallel to web 130.

To reinforce web 130, bracket 128 may include upwardly extending flanges 160, such as tapered or generally triangular shaped flanges. Further, bracket 128 may include a rearwardly extending (as viewed in FIG. 18 and seen in FIGS. 11 and 14) horizontal flange 162 that extends under frame 114 for securement, such as by welding, to the underside of the respective frame members 114a, 114b.

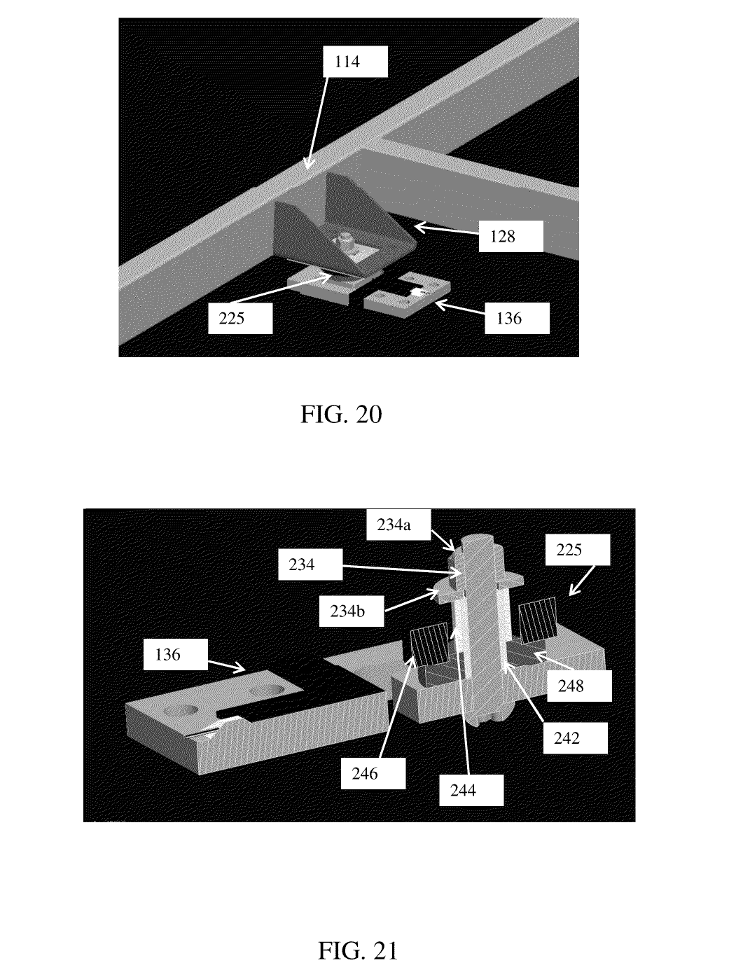

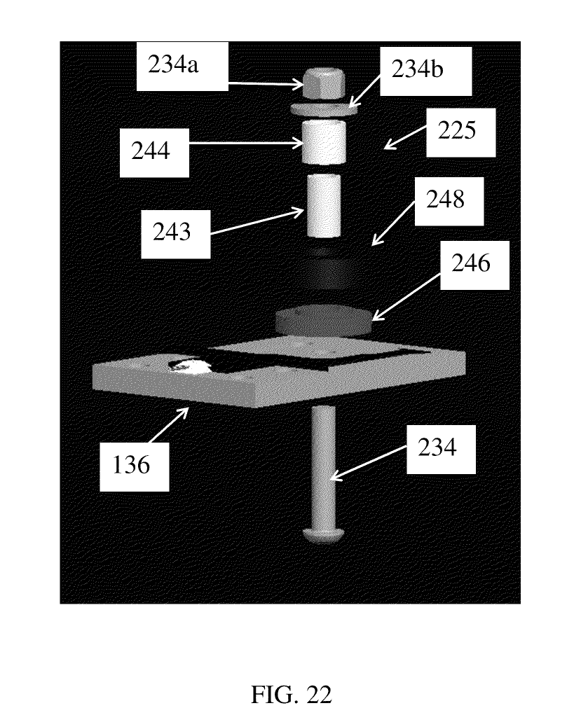

Referring to FIGS. 20-22, the numeral 225 designates another embodiment of the load cell mounting assembly. Load cell mounting assemblies 225 similarly mount frame 114 to load cells 136 by way of brackets 128. Load cell mounting assemblies 225 also provide a barrier to protect the load cells from direct force transmission between the frame and the load cells.

In the illustrated embodiment, each load cell mounting assembly 225 includes a coupler, such as a mounting bolt 234, which extends up through the respective load cell 136. Mounted about bolt 234 are an inner compression sleeve 242 and a damping bushing 244, which is concentrically mounted about inner compression sleeve 242. For example, sleeve 242 is formed from a metal, such as steel. Damping bushing 244 is formed from a polymer, such as nylon. Bolt 234 similarly is secured in bracket 128 by a nut 234a and washer 234b, which rests on sleeve 242 and bushing 244 and captures bolt 234 in slotted opening 132. Sandwiched between web 130 and load sensor 136 are a slider 246 and an outer rotating sleeve 248. Slider 246 comprises an annual body, formed from a polymer, such as plastic. Sleeve 248 also comprises an annular body with a raised shoulder on which sleeve 244 rests and against which the inner surface of slider 246 abuts. Sleeve 248 is formed from a material that absorbs vibration, such as an elastomeric material, including rubber.

In this manner, similar to the previous embodiment, when a lateral force is applied to frame 114, bracket 128 will translate relative to bolt 234 due to the slotted opening interface. In other words, frame 114 will translate relative to the bolt in the direction of the long axis of the slotted opening. Forces that are normal to the slotted opening long axis will be absorbed by sleeve 248 and sleeve 246. Again, the orientation of the slot openings may be varied, such as shown in FIG. 13, where two of the slotted openings have their long axes 132a parallel to the long or longitudinal axis of frame 114, while the other two have their longitudinal axes 132a extending generally normal to the longitundinal axis of frame 114.

The above description is that of several embodiments of the invention. Various alterations and changes can be made from these embodiments without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

We claim:

1. A patient support comprising:
a first structure;
a second structure adapted to support the weight of a patient and spaced from the first structure;
at least one force sensor mounted to the first structure; and
a mounting assembly that is configured to transfer normal forces from the second structure to the force sensor but absorb lateral forces from the second structure.

2. The patient support according to claim 1, wherein the mounting assembly includes at least one damping structure to absorb lateral forces from the second structure.

3. The patient support according to claim 2, wherein the damping structure comprises an annular member.

4. The patient support according to claim 2, wherein the annular member comprises an elastomeric material.

5. The patient support according to claim 1, wherein the mounting assembly includes plural damping structures to absorb lateral forces from the second structure.

6. The patient support according to claim 5, wherein the plural damping structures comprise ribs, the ribs being configured to compress or collapse in response to a lateral force.

6. The patient support according to claim 1, wherein the mounting assembly includes two concentric sleeves.

7. The patient support according to claim 6, wherein the concentric sleeves are spaced by ribs.

8. The patient support according to claim 7, at least one group of the ribs having a uniform cross-section.

9. The patient support according to claim 7, at least one group of the ribs having a non-uniform cross-section.

10. A patient support comprises:
a first structure;
a second structure adapted to support the weight of a patient;
at least one force sensor mounted to the first structure; and
a mounting assembly configured to transfer normal forces from the second structure to the force sensor, the mounting assembly including a sliding interface between the second structure and the force sensor along a first axis and a damping interface along a second axis angled with respect to the first axis so that lateral forces are absorbed by the mounting assembly.

11. The patient support according to claim 10, wherein the mounting assembly includes a coupler, the coupler mounting to the force sensor, the mounting assembly further including a slotted opening for receiving the coupler.

12. The patient support according to claim 11, wherein the mounting assembly further includes a sleeve surrounding the coupler, the sleeve configured to absorb lateral loads at the sliding interface to form the dampening interface.

13. The patient support according to claim 12, wherein the sleeve comprises a first sleeve, and the mounting assembly includes a second sleeve, the second sleeve spaced from the first sleeve.

14. The patient support according to claim 12, wherein the first and second sleeves are joined by ribs, the ribs being designed to compress or collapse in response to lateral forces applied at the interface.

15. A patient support comprising:
a first structure;
a second structure adapted to support the weight of a patient and spaced from the first structure;
at least one force sensor mounted to the first structure; and
an elastic member mounted to the second structure and connected to the sensor by a coupler, the coupler not being directly coupled to the second structure wherein when forces from the second structure are transferred to the elastic member the elastic member absorbs some of the forces from the second structure thereby transferring only some of the forces from the second structure to the coupler and to the sensor.

16. The patient support according to claim 15, wherein the elastic member includes at least one flange, the flange being mounted to the second structure.

17. The patient support according to claim 16, wherein the flange comprises a pair of flanges.

18. The patient support according to claim 17, wherein the elastic member includes a hollow region facing the second structure.

19. The patient support according to claim 18, wherein the mounting flanges are located about the hollow region, and the flanges mounting the elastic member to the second structure.

20. The patient support according to claim 15 wherein the elastic member has a cylindrical body.
